(19) United States
(12) Patent Application Publication
(10) Pub. No.: US 2006/0061105 A1
(43) Pub. Date: Mar. 23, 2006

(54) Wind electricity vehicle

(76) Inventor: Seok Il Yun, Houston, TX (US)

Correspondence Address: Seok Il Yun, 10418 North New Park, Houston, TX, 77041, US

(21) Appl. No.: 10/808,943

(22) Filed: Sep. 20, 2004

(51) Int. Cl. H02K 7/18; F03G 7/08; F02B 63/04

(52) U.S. Cl. 290/1 R

(57) ABSTRACT

The car runs on twelve DC 12 volt batteries. One battery is 12 volt and 145 Ampere. So the total equals up to 144 volts and 1740 Ampere. We use a DC motor from 120-144 volts. The car starts from 450 Ampere to 500 Ampere. While it's moving it forms 200-250 Ampere. From this description it travels about a full distance of 1-2 hours. As the car runs it generates energy from the four wheels which is connected to the generators and the generator runs from the wind. From the back two wheels it creates 72 volts and from the two wheels in the front it creates 24 volts. All together it creates 96 volts. From the wind it creates 48-60 volts. Every 12 volts it creates 250 ampere. We can control how much ever energy can be produced depending on the wind and the wheels, also the size of the car.

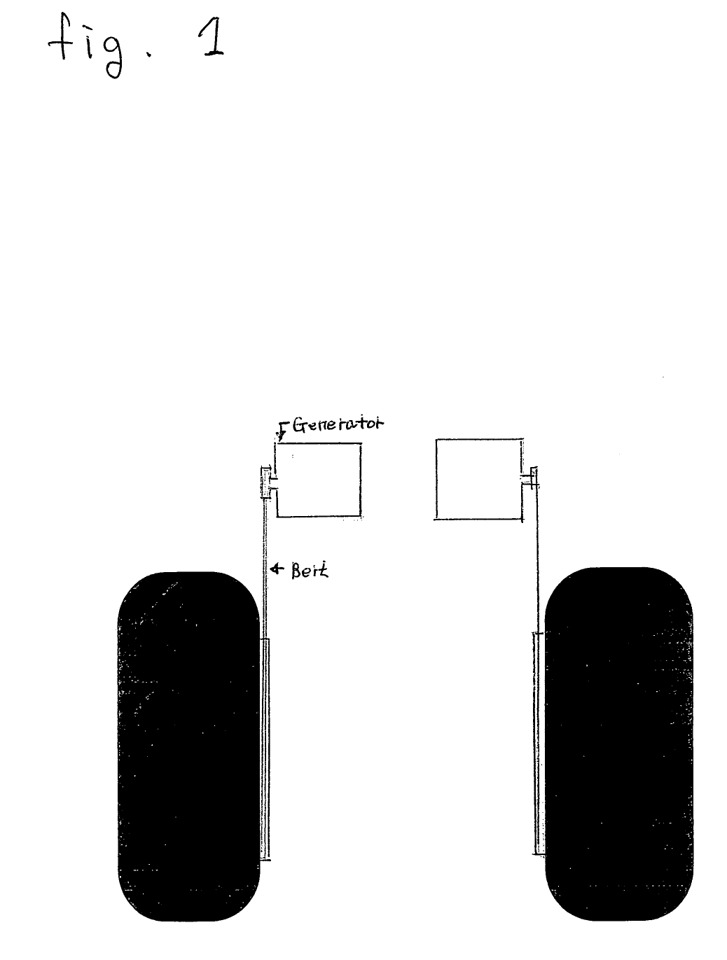

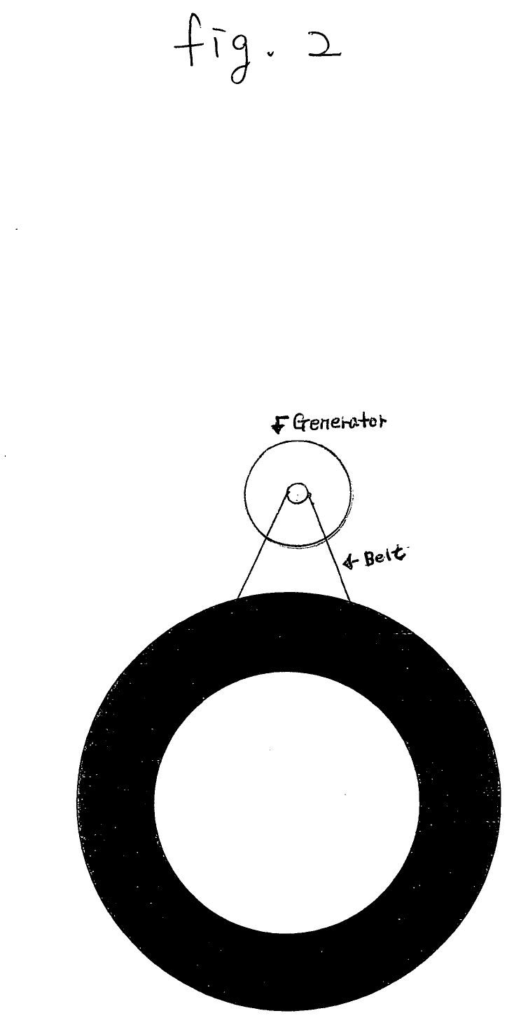

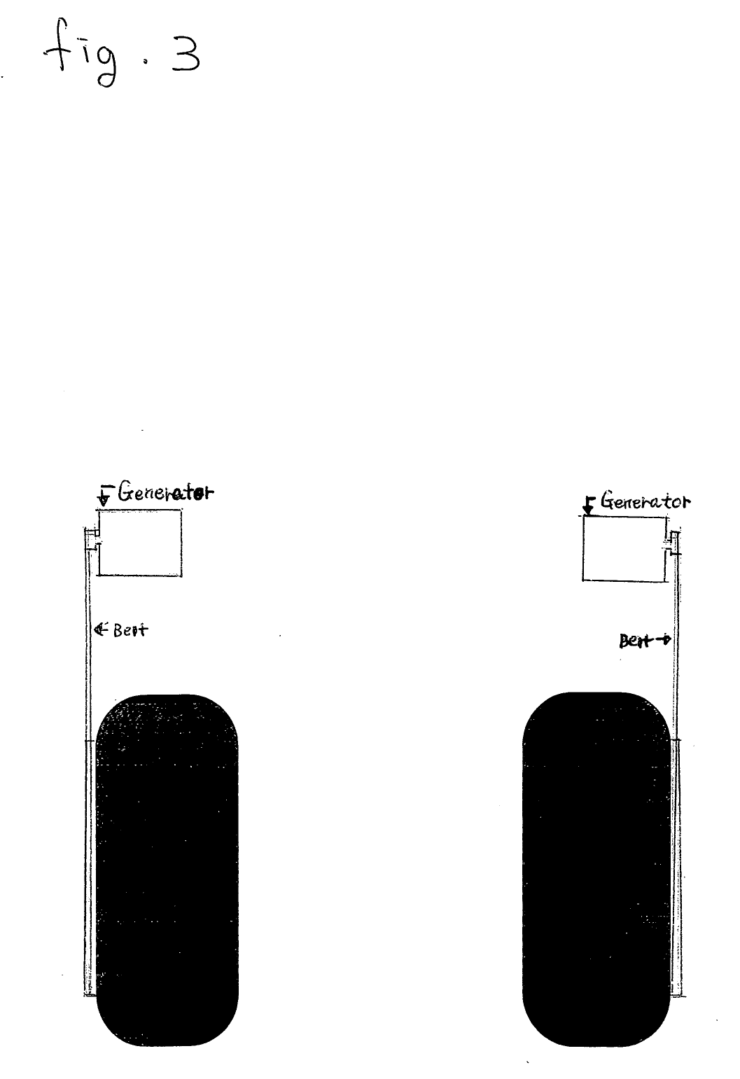

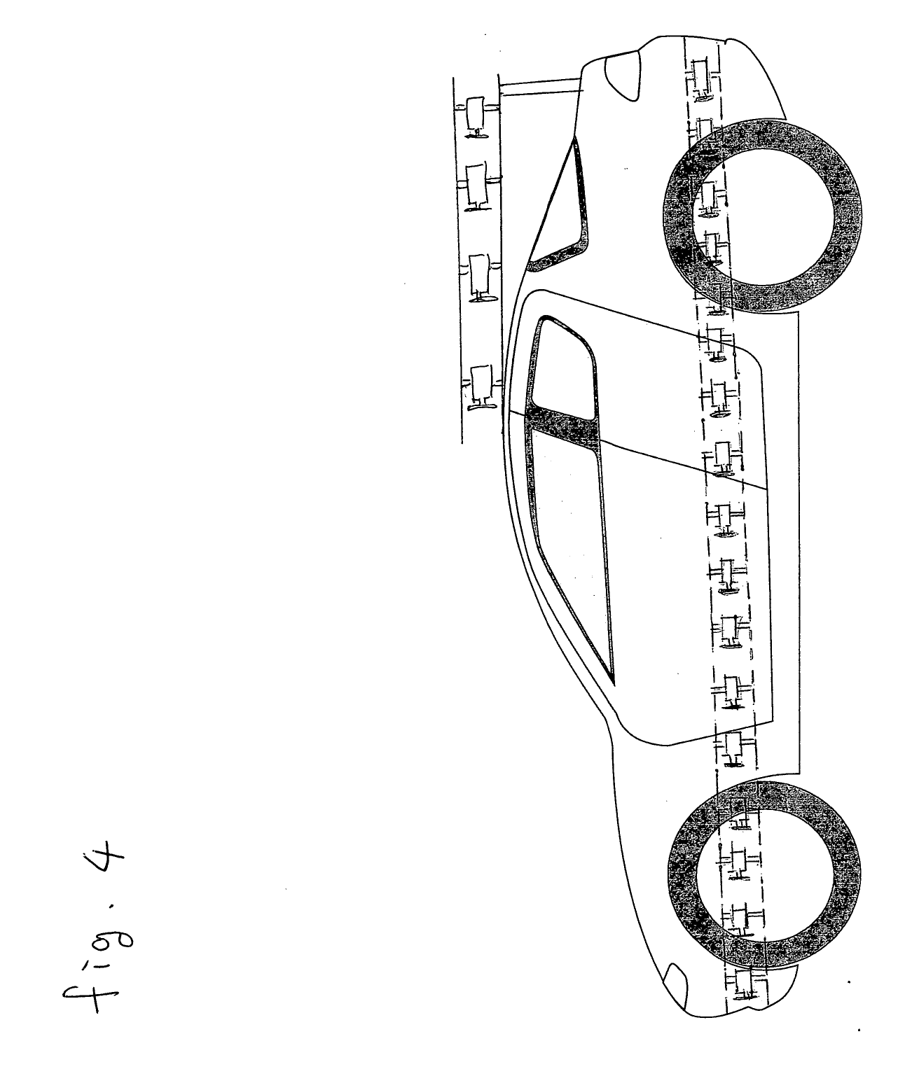

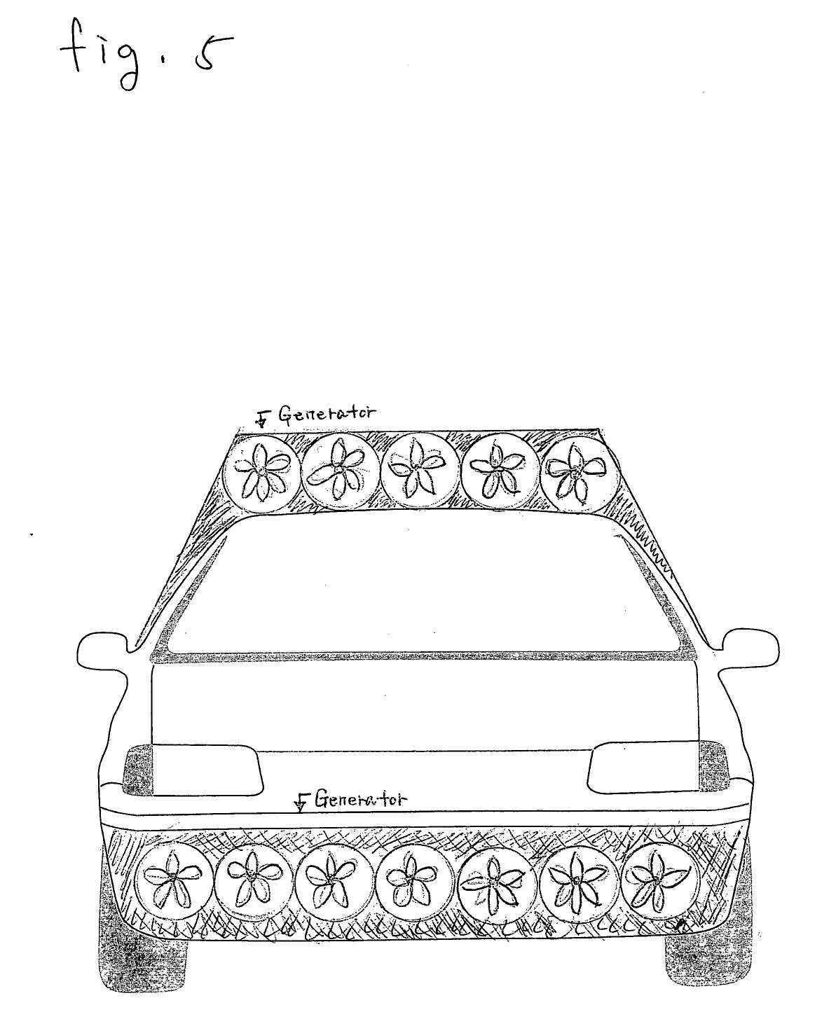

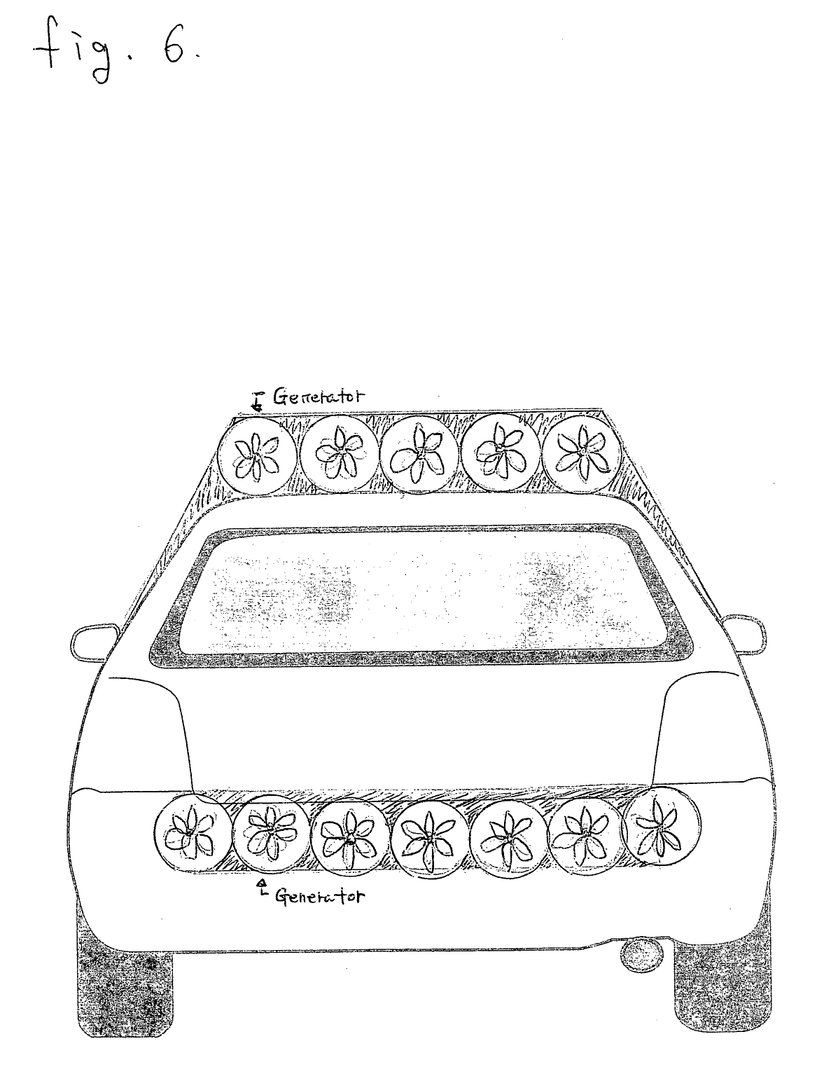

Today, there are many types of vehicles driven around the world. Fossil fuels are what powers most of these vehicles. The problem is that we are using up the earth's resources faster than they are produced. They are becoming more expensive and also create pollution.

I have found a way to propel vehicle without the use of fossil fuels or electricity. Engineers, scientists, and car companies have been working for years to try and come up with a way to make this possible. Gratefully, God has blessed me with a great idea of this wonderful invention, wanting me to help the people of this world.

Throughout the world, scientists have developed an electric motor. Problem with using electricity is that they can only run two to three hours before having to recharge. Why is that? Because of the battery. Every 180 km to 240 km, the vehicle has to stop and recharge for six to eight hours. They spend more time charging than driving which is not reasonable. My new invention is called, “EV Forever”. “Once fully charged it never needs charging again”.

Let me explain my concept.
1. We start “forever” with a battery. It has four wheels with a belt connected to each one. Each of these four belts connected to four generators. With one rotation of all four wheels each generators spin 20 times which adds up to 80 times peroration of the wheels which allows the generators to produce large amounts of electricity to recharge the battery. This allows me to recycle 30% to 40% of the electricity which is needed.
2. Let's use natural power. The vehicle uses wind to propel itself.
   20 mph speed makes 20 mph wind
   50 mph speed makes 50 mph wind
   100 mph speed makes 100 mph wind

I also have a fan which is connected to another generator. All of them generated electricity goes to the main battery to continue to produce energy. There are several generators attached from the front to the bottom of the car and 20 to 30 more on top of the car. We can create momentum and energy from the wind. From the wheels I can recover 30% to 40% of the energy used from the remaining generators. I can recover up to 150% more energy. When the vehicle travels over 10 mph, electricity is created by the wind. When in traffic or during turning points the energy is created from the wheel. So this concept always creates electricity. If we use this “Forever” concept without gas or charging battery, we can use this forever.

This concept is simple and inexpensive to produce. It is also very reliable. If it does break down, repairing is an easy and a quick job to do. My goal is to travel around U.S. after this product is made and prove to the world the first prototype made.

WE HAVE ALREADY SUCCEEDED THIS EXPERIMENT.

If you need any information, please feel free to contact me. I will provide you with any documentations, pictures, and also videos as soon as possible.

1. I claim an electric vehicle.
